(19) United States
(12) Patent Application Publication
(10) Pub. No.: US 2012/0321919 A1
(43) Pub. Date: Dec. 20, 2012

(54) BATTERY CASE FOR RECEIVING ELECTROCHEMICAL ENERGY-STORAGE DEVICES

(75) Inventors: Tim Schaefer, Harztor (DE); Andreas Gutsch, Luedinghausen (DE)

(73) Assignee: Li-Tec Battery GmbH, Kamenz (DE)

(21) Appl. No.: 13/516,677

(22) PCT Filed: Nov. 22, 2010
(86) PCT No.: PCT/EP2010/007064

§ 371 Date: Sep. 4, 2012

(30) Foreign Application Priority Data
Dec. 16, 2009 (DE) 10 2009 058 444.7

(51) Int. Cl. H01M 2/02; H01M 10/42; H01M 2/10

(52) U.S. Cl. 429/50; 429/185; 429/151; 429/61

(57) ABSTRACT

A battery case includes a deformable lateral wall. The battery case is provided to receive at least one electrochemical energy storage device. An electrochemical energy storage device includes a cell frame, which partially surrounds the device and in some areas forms the outer wall of the battery case. The battery case also includes a case cover, by which at least one electrochemical energy storage device can be electrically contacted. A lateral wall forms at least in some areas the outer wall of said battery case, wherein the stiffness of said lateral wall is less than the stiffness of the cell frame. When there is a pressure difference between the inner space of the battery case and the environment around the battery case, the lateral wall is therefore deformed and the volume of the battery case increases. The lateral wall is connected at least in some areas to said cell frame in a gas-tight manner.

### CROSS-REFERENCE TO RELATED APPLICATIONS

This application is a national stage application under 35 U.S.C. §371 of International Application No. PCT/EP2010/007064, filed Nov. 22, 2010 and published as WO 2011/072793, which claims priority to German patent application number DE 10 2009 058 444.7, filed Dec. 16, 2009, the entirety of each of which is hereby incorporated herein by reference.

### SUMMARY

The present invention relates to a battery case having a lateral wall for receiving electrochemical energy storage devices and a method for operating this battery case. The invention is described in the context of lithium-ion batteries for supplying the drive motor in a motor vehicle. It is noted that the invention is also usable without reference to the construction type of the battery or to the type of drive unit the batteries are intended to power.

Batteries comprising multiple electrochemical energy storage devices and a battery case having a rigid lateral wall, are known from the prior art and are described for example in EP 1 583 167 A1. A common drawback of some battery case designs is that if an energy storage device fails, the contents of the cell can escape and may damage the surrounding area.

The object of the invention is therefore in particular to prevent components of an electrochemical storage device, including gas-phase components, from escaping uncontrollably from the battery case, and thus improve the safety of the battery.

This is achieved according to the invention by the teaching as disclosed herein. Preferred developments of the invention are described herein.

A battery case is designed for the purpose of receiving at least one electrochemical energy storage device and to protect it from external influences such as mechanical stresses or UV radiation and the like.

Such an electrochemical energy storage device comprises a cell frame. This frame at least partially surrounds the energy storage device and in some areas also forms the outer wall of the battery case. This battery case also comprises a case cover. At least one electrochemical energy storage device may be electrically contacted via this case cover.

The battery case comprises at least one lateral wall. This lateral wall forms the outer wall of this battery case at least on some areas. The stiffness of this lateral wall is less than the stiffness of the cell frame. As a result of these differing in stiffnesses, essentially the lateral wall undergoes elastic and/or plastic deformation due to the pressure differential between the inner space of the battery case and the atmosphere surrounding the battery case.

This deformation of the lateral wall causes an increase in the volume of the battery case. To enable this deformation of the lateral wall, it is connected in gas-tight manner to a cell frame at least in certain areas.

The term lateral wall is used to refer to a partial area of a battery case. This lateral wall is provided so that it may undergo deformation when a pressure differential exists between the battery case inner space and the atmosphere surrounding the battery case. Such a pressure differential may occur particularly as a result of uncontrolled reactions of the electrochemical energy storage device, in the event of a “thermal runaway” for example, and the associated rise in pressure in the inner space of the battery case. In particular, the deformation of this lateral wall enlarges the surface area of the battery case and increases the volume of the inner space of the battery case. These changes preferably have a positive effect on the pressure differential between the inner space of the battery case and the surrounding atmosphere, that is to say the pressure in the inner space of the battery case increases less sharply than it would if this lateral wall were not to undergo deformation. This reduced pressure differential thus diminishes the mechanical stresses on the battery case and increases the safety thereof.

The term electrochemical energy storage device is used to refer to a device that is provided for storing electrical energy. An electrochemical energy storage device includes at least one electrode stack, one current collector and one wrapping element. An electrochemical energy storage device is provided to convert electrical energy into chemical energy and store it. Conversely, the electrochemical energy storage device may also convert the chemically stored energy back into electrical energy and release it. Such an electrochemical energy storage device is preferably designed as a rechargeable lithium-ion battery. In particular, an electrochemical energy storage device comprises reactive contents. The wrapping element prevents these contents from reacting in uncontrolled manner with the atmosphere that surrounds the electrochemical energy storage device.

The term cell is frame is used to refer to a component that is in mechanical contact with the wrapping element of an electrochemical energy storage device. The cell frame surrounds the electrochemical energy storage device essentially around the edges thereof. In particular, the cell frame serves to protect the wrapping element and to enable the electrochemical energy storage device to be positioned or stacked. The cell frame particularly serves to protect certain preferably sensitive areas of this wrapping element. External loads on the wrapping element are reduced by the cell frame. In particular, the cell frame covers the weld seams and adhesion points on the wrapping element.

For the purposes of the invention, the term outer wall is used to refer to the area of a battery case that separates the inner space of the battery case from the environment surrounding the battery case. The outer wall of the battery case is preferably intended to isolate the content of the battery case from environmental influences such as mechanical loads. In particular, this outer wall prevents substances that have escaped from the electrochemical energy storage device from coming into contact with the environment surrounding the battery case.

A case cover is the term used to refer to a component that is a component of the battery case. The case cover may preferably be attached to the cell frame. The electrochemical energy storage devices are preferably electrically contactable through the case cover. In particular, an electronic controller is inserted in the case cover. Such a battery controller is preferably provided for the purpose of actuating the electrochemical energy storage devices of at least one battery.

For the purposes of the invention, activation of the electrochemical energy storage devices is used to indicate that the electrical contacting of single or all electrochemical energy storage devices of a battery is interrupted or rather controlled. In particular the electrical contacting may be controlled such that the output derived from the stored energy is influenced. This is effected preferably by controlling the voltage at the current collectors, and particularly preferably by controlling the current that is derived from the energy stored in the electrochemical energy storage devices.

Control of this voltage or current is effected particularly on the basis of the status of at least one electrochemical energy storage device, for example with respect to its temperature, or preferably the pressure differential between the inner space of the battery case and the atmosphere surrounding the battery case.

In this way, the content of the electrochemical energy storage device is prevented from escaping from the battery case, and in this way the underlying object of the invention is solved. Preferred refinements of the invention will be described in the following.

In a preferred embodiment of the battery case, at least two cell frames from two adjacent electrochemical energy storage devices are connected to each other by a form-locking, bonded or force-locking manner. In particular, this connection is designed to be gas-tight. The gas-tight design of this connection ensures that that no substances are able to escape from the battery case in uncontrolled manner. This in turn prevents the environment from being contaminated by reactive substances from the electrochemical energy storage devices. The safety of an electrochemical energy storage device is thus increased.

In particular, two adjacent cell frames are connected to each other in form-locking manner. Such a connection may particularly be created with connecting elements. In particular, the cell frames are furnished with recesses, preferably boreholes, for the purpose of forming this connection. In particular, a form-locking connection between these cell frames is created by the connecting elements in cooperation with these recesses. Such connecting elements may particularly be screws, rivets or pins. In particular, connection areas are created on a cell frame, so that two adjacent cell frames form a preferably form-locking connection with one another. Such a form-locking connection is particularly constructed as a “snap-on connection”.

In a preferred embodiment, two adjacent cell frames are connected to one another in bonded manner. In particular, such a bonded connection is created by adhesion or welding. This bonded connection is preferably designed to be gas-tight. This type of connection serves to prevent substances from escaping in uncontrolled manner from the battery case and into the environment, thereby increasing the safety of the electrochemical energy storage device.

In a preferred embodiment, the lateral wall is connected to at least one cell frame in bonded manner. Such a bonded connection is preferably created by adhesion or welding. In particular, this type of connection produces a gas-tight connection between the lateral wall and the cell frame. This connection is preferably as strong as or stronger than the tensile strength of the lateral wall. This relationship between these two strengths ensures that the connecting elements between the lateral wall and the cell frame do not fail before lateral wall begins to deform. In particular, this embodiment ensures that the lateral wall deforms and contents of the electrochemical energy storage device do not escape in uncontrolled manner from battery case.

In a preferred embodiment, the lateral wall is connected to the cell frame in force-locking or form-locking manner. The lateral wall is preferably connected to the cell frame by clamping with a reinforcing frame. In this context, this clamping connection is particularly constructed such that the tensile strength of the clamping connection is greater than or equal to the tensile strength of the lateral wall. Such a construction of this connection particularly ensures that the lateral wall deforms and the connection does not fail, so that the contents of the electrochemical energy storage device do not escape from the battery case in uncontrolled manner. This design of the connection particularly increases the safety of the battery case.

In a preferred embodiment of the battery case, significant pressure differences are prevented from occurring inside the battery case for extended periods. In particular, pressure differences of more than 1*10⁵ pascal are prevented from existing for longer than 5 seconds, preferably for longer than 2 seconds and particularly for longer than 1/10 second. This pressure equalisation is preferably achieved by means of pressure equalisation recesses. Such pressure equalisation recesses may particularly be located in the cell frames. In particular, these pressure equalisation recesses serve to ensure that a battery case has only one common, contiguous inner space, and this optimal use of the volume of the battery case inner space increases safety.

In a preferred embodiment, a battery case comprises an electronic battery controller for controlling at least one electrochemical energy storage device. In particular, this battery controller is incorporated in a cover element. In particular, a cover element may cover a battery controller at least partially, but preferably completely.

In a preferred embodiment, the lateral wall of a battery case is made from a composite material. In particular, this composite material is a fibre-reinforced plastic. An elastomer is preferably used as the base or matrix substance for this fibre-reinforced composite. In particular, the reinforcing fibres in this material are aligned multidirectionally, preferably in a predefined direction or unidirectionally. Multidirectional alignment of the reinforcement fibres rather serves to increase the component strength of this lateral wall and therewith the safety of the battery case as well. If the reinforcement fibres are deliberately prealigned, for example unidirectionally, this rather has a greater effect on the deformation of the lateral wall. In particular, this achieves a directed, locally variable deformation of this lateral wall. Such a directional deformation of the lateral wall particularly serves to ensure that it expands into existing cavities or recesses that surround the battery case. Such a directed deformation particularly serves to prevent uncontrolled contact with objects that surround that battery case, for example parts of the frame or other battery cases, thereby increasing the safety of the battery case.

The reinforcement fibres of this fibre composite material fort this lateral wall according to the invention are preferably made from a plastic. In particular, this plastic exhibits expansion behaviour that differs from that of the base material. In particular, these reinforcement fibres are made from nylon or aramid. In particular, the reinforcement fibres may also be made from a material group other than plastic, for example they may be glass, metal, ceramic or carbon fibres. In particular, the reinforcement fibres have a thickness from 1 μm to 1000 μm, preferably from 10 μm to 100 μm and particularly preferably from 20 μm to 40 μm. The expansion behaviour of these reinforcement fibres may be influenced particularly by their geometry, for example by their cross-sectional area normal to the direction of principal stress, or preferably by their modulus of elasticity. It is possible to influence the deformation behaviour of this lateral wall and thus increase the safety of battery case via the different expansion behaviours of the reinforcement fibres and the base material.

In particular, at least part of the lateral wall is made from a plastic having a breaking elongation from 100%-1000%, such as polyolefin, from a plastic having a breaking elongation from 50%-500%, such as polyamide, or from a plastic having a breaking elongation from 5%-80%, such as polycarbonate. At least part of the lateral wall is preferably made from a plastic from the ethylene propylene diene (EPDM) group. In particular, this plastic is not vulnerable to the contents of an electrochemical energy storage device and cannot be chemically attacked or decomposed by the products of reaction released thereby. In particular, a coating or a protective device prevents reactive contents from coming into contact with this lateral wall. In particular, the reactive substances may be prevented from escaping from the battery case by selection of a suitable plastic for the lateral wall, thus rendering the battery case safer.

In particular, a battery comprises at least one electrochemical energy storage device and one battery case. This battery case has at least one, preferably two or more particularly elastically or plastically deformable lateral walls. At least one electrochemical energy storage device is preferably accommodated in this battery case.

A method for operating a battery with a battery case is understood to mean a method that in particular records measured values from the battery case, processes them and influences the operating state of the battery or displays this operating state on the basis of such measured values. The recording of measured values is particularly understood to include the measurement of a pressure, a temperature or other physical variables that may preferably be used to evaluate the operating state of one or more electrochemical energy storage devices. In particular, processing of measured values is understood to mean performing a target/actual value comparison. This processing is particularly designed to convert the result of this target/actual value comparison into a control command. In particular, this control command is suitable for changing or influencing the operating state of at least one electrochemical energy storage device. Influencing the operating state of the battery is understood to mean that the electrical contacting of at least one electrochemical energy storage device is preferably interrupted or particularly restricted. In this way, the output derived from this electrochemical energy storage devices is limited.

By such a method, the electrochemical energy storage devices are prevented from operating for extended periods above their performance limit, and they are thus rendered safer.

In particular, in a method for operating a battery the temperature of at least one electrochemical energy storage device is measured. This measured temperature is compared with a target temperature. If the measured temperature exceeds a predefinable shutoff value, particularly the electrical contact with this one electrochemical energy storage device is interrupted or preferably the electrical contact with the entire battery is interrupted. It is particularly preferred if the output derived either from the one electrochemical energy storage device or from the entire battery is reduced. The safety of the battery is increased by switching off an electrochemical energy storage device or a battery that is overheated, for example.

In particular, in a method for operating a battery the pressure inside a battery case or preferably a surface pressure is measured, for example by measuring a force preferably normal to the surface of at least one electrode of the electrochemical energy storage device. Preferably, the pressure or surface pressure may also be recorded inside an electrochemical energy storage device. The measured value of this surface pressure or pressure is particularly compared with preferably predefinable shutoff value in a target/actual value comparison. If the measured value exceeds this shutoff value, the electrical contact of at least one, but preferably of all electrochemical energy storage devices will preferably be interrupted. In particular, the derived output from at least one, but preferably from all electrochemical energy storage devices may be limited when this shutoff value is reached. These shutoffs of electrochemical energy storage devices or the limitation of the derived output therefrom if the mechanical load to which they are exposed is too great increase safety.

In particular, the battery controller may emit a signal when a critical operating state is reached. In this context, a critical operating state is characterized particularly by measurable physical parameters such as the pressure in the battery case, the surface pressure acting on the surface of the electrode stack, or the temperature of an electrochemical energy storage device. The signal output may particularly be an optical signal, such as a change in the colour or shape of areas of the battery case, for example a pin protruding from the battery case, or an electrical signal. In particular, such a signal may be processed further by a control unit. In particular, this signal may be used for evaluating the operating state of the battery or at least one of this battery's electrochemical energy storage devices.

Other advantages, features and application possibilities of the present invention will be evident from the following description with reference to the drawing. In the drawing:

### BRIEF DESCRIPTION OF THE DRAWINGS

FIG. 1 shows a cross-section through a battery case 1 according to the invention having two deformable lateral walls 2. Battery case 1 comprises four electrochemical energy storage devices 3. A battery controller 6 is incorporated in a cover element 5. These electrochemical energy storage devices 3 are surrounded by cell frames 4. This battery case 1 has two electrical connections 7.

FIG. 2 shows a cross-section through a battery case 1 according to the invention without a cover element 5 and with two electrochemical energy storage devices 3. These are surrounded by cell frames 4. Cell frames 4 are furnished with pressure equalisation recesses 9.

FIG. 3 shows a cross-section through a battery case 1 according to the invention. Cell frames 4 surround electrochemical energy storage devices 3 and are connected to each other in form-locking manner. Lateral walls 2 are also connected to cell frames 4 via a cell frame snap-on connection 8.

FIG. 4 shows a cross-section through a battery case 1 according to the invention. Cell frames 4 surround electrochemical energy storage devices 3. Cell frames 4 are connected to each other via through bolts 10. Lateral walls 2 are also connected to cell frames 4 via these through bolts 10.

FIG. 5 shows a cross-section through a battery case 1 according to the invention. Cell frames 4 surround electrochemical energy storage devices 3. Cell frames 4 are connected to each other via through bolts 10. The peripheral areas of lateral walls 2 are reinforced with a reinforcement frame 12 and are also connected to cell frames 4 via these through bolts 10.

FIG. 6 shows a cross-section through a battery case 1 according to the invention. Cell frames 4 surround electrochemical energy storage devices 3. Cell frames 4 are connected to each other by adhesion. Lateral walls 2 are connected to cell frames 4 via a cell frame snap-on connection 13.

FIG. 7 shows a side view of a battery case 1 according to the invention having a deformed lateral wall 2b, wherein lateral wall 2b exhibits homogeneous stress-strain behaviour.

FIG. 8 shows a side view of a battery case 1 according to the invention having a deformed lateral wall 2a, wherein lateral wall 2a exhibits non-homogeneous stress-strain behaviour.

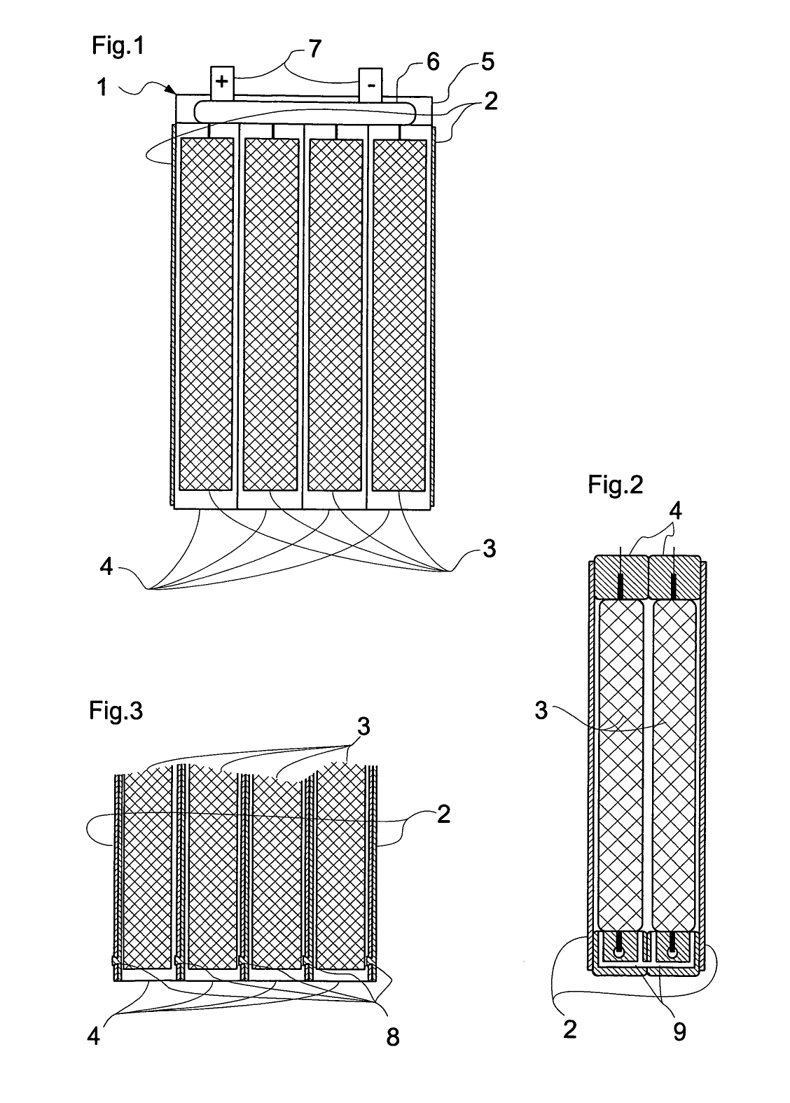

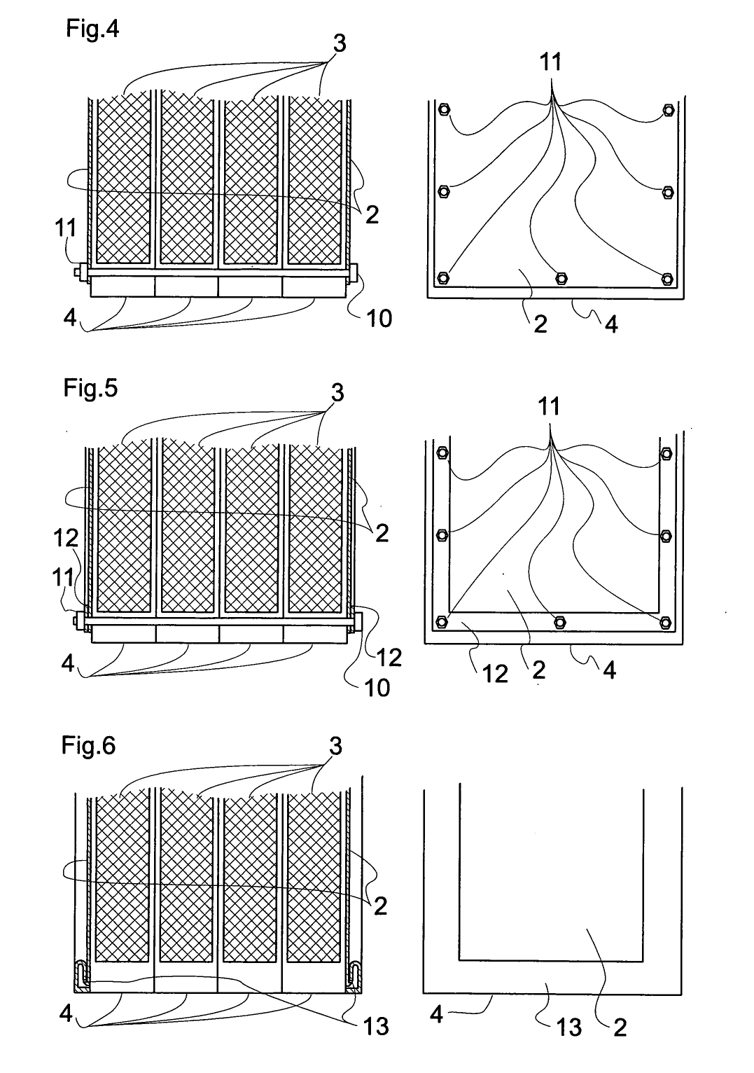

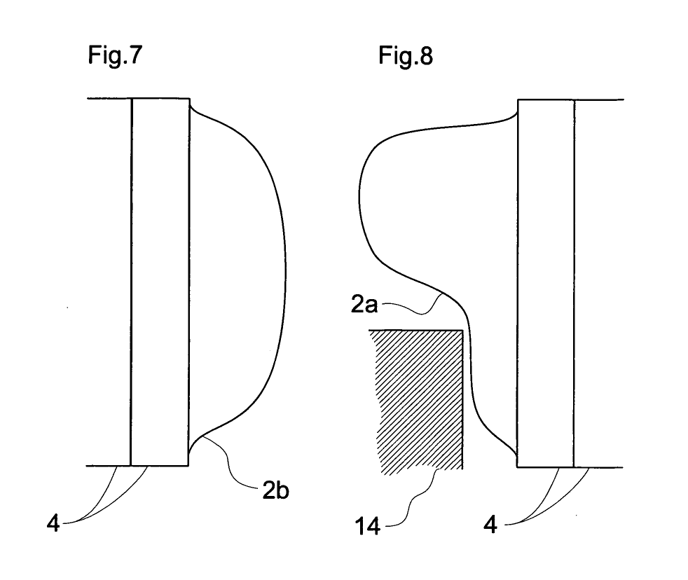

### DETAILED DESCRIPTION

In a preferred embodiment, a battery case 1 according to the invention comprises two deformable lateral walls 2. Electrochemical energy storage devices 3 are surrounded by cell frames 4. A section of cell frame 4 forms part of the outer surface of battery case 1. A battery control device 6 is accommodated in cover element 5 of this battery case 1. Electrochemical energy storage devices 3 are contactable via electrical contacts 7 and through battery control device 6. Two adjacent cell frames 4 are connected to one another in bonded manner, preferably by adhesion or welding. Lateral walls 2 are also connected in bonded manner to cell frames 4. The fluid-tight connections between lateral walls 2 and cell frames 4 and the connections of cell frames 4 with each other make it impossible for substances to leak into or out of battery case 1 in uncontrolled manner.

In a particularly preferred embodiment, cell frames 4 are furnished with pressure equalisation recesses 9. These pressure equalisation recesses 9 connect the spaces between electrochemical storage devices 3 in such manner that a common inner space of the battery case is created. This means that no pressure differences exist for prolonged periods in this common inner space. Consequently, if the pressure increases inside the battery case this pressure is distributed evenly throughout the entire inner space of the battery case.

In a preferred embodiment, cell frames 4 of a battery case 1 according to the invention are connected to each other via a cell frame snap-on connection 8. In this embodiment, lateral walls 2 are preferably also connected in form-locking manner to cell frames 4. This form-locking connection is designed as a snap-on connection. In this way, lateral walls 2 are connected to cell frames 4 in fluid-tight manner. Cell frames 4 are also connected to each other in fluid-tight manner. In this way, no contents of electrochemical energy storage devices 3 are able to escape from battery case 1 in uncontrolled manner.

In a preferred embodiment, cell frames 4 are connected to each other in form-locking manner. For this form-locking connection, connecting elements as well as other means are used. One such connecting element is for example a through bolt 10 and a nut 11. Through bolt 10 passes through several cell frames 4. When through bolt 10 is tightened against nut 11, cell frames 4 are forced against each other. It is advantageous if lateral walls 2 are also attached to the connecting elements in fluid-tight manner. As a result of this tightening action, a fluid-tight connection is thus created between cell frames 4 and lateral walls 2. This fluid-tight connection serves to prevent substances in electrochemical energy storage devices 3 from leaking out of battery case 1 or other substances from getting into the battery case in uncontrolled manner.

In a preferred embodiment, cell frames 4 and lateral walls 2 are connected via through bolts 10 and nuts 11. In order to improve the safety of the connection between lateral wall 2 and cell frame 4, a reinforcement frame 12 is inserted between the bolt head or the nut 11 and lateral wall 2. This reinforcement frame 12 may be connected to lateral wall 2 in bonded manner, or it may be formed by folding back the border of lateral wall 2. Reinforcing frame 12 has the effect of distributing the pressure from the screw pretension forces evenly throughout lateral wall 2. This reinforcing frame 12 enables a particularly secure connection with high impermeability to be created. This ensures that no contents of electrochemical energy storage devices 3 are able to leak out of battery case 1 or other substances are able to get into the battery case in uncontrolled manner.

In a preferred embodiment, cell frames 4 are connected to each other in bonded manner. Such a bonded connection may be realised by adhesion or preferably by welding. Lateral walls 2 are connected to the outer cell frames 4 by a form-locking connection. Such a form-locking connection is advantageously realised with a lateral wall snap-on connection 13. This lateral wall snap-on connection 13 connects lateral walls 2 with the outer cell frames 4 in fluid-tight manner. In this way, contents of electrochemical energy storage devices 3 are prevented from escaping in uncontrolled manner from battery case 1.

If the pressure inside battery case 1 increases, deformable lateral wall 2 is able to bulge outwards. When lateral wall 2b bulges outwards, this increases the volume of battery case 1. This increase in volume causes the pressure inside the battery case to rise less sharply than it would if the battery case volume were to remain unchanged. As a result of this less rapid pressure increase, the mechanical load on battery case 1 is reduced and safety increased.

In a preferred embodiment, lateral wall 2a exhibits non-homogeneous stress-strain behaviour. This behaviour may be achieved in targeted manner with a fibre composite material or via geometrical properties, for example with a lateral wall 2a of variable thickness. Finally, this stress-strain behaviour affects the deformation behaviour of lateral wall 2a. This deformation behaviour may be exploited such that lateral wall 2a does not collide with other components, for example frame components 14, as it deforms. Lateral wall 2a then expands only in such a way that it does not come into contact with other, particularly sharp-edged, components. In a lateral wall with homogeneous stress-strain behaviour, the lateral wall expands essentially evenly until the component strength limit is reached, and the battery case inner space thus expands to its maximum size.

1-14. (canceled)

15. A battery case for receiving at least one electrochemical energy storage device, the battery case comprising:
a cell frame that surrounds the battery case and in certain areas forms the outer wall of the battery case; and
a case cover, via which at least one electrochemical energy storage device is electrically contactable, and at least one lateral wall, which forms at least sections of the outer wall of the battery case, wherein
the stiffness of the lateral wall is lower than the stiffness of the cell frame,
the lateral wall is configured to deform and thereby increase the volume of the battery case,
the lateral wall is connected to the cell frame in gas-tight manner at least in certain areas, and
at least two cell frames are connected to each other in form-locking manner via a connecting element.

16. The battery case as recited in claim 15, wherein the at least two cell frames are connected to each other in bonded manner by adhesion or welding.

17. The battery case as recited in claim 15, wherein cell frames of two adjacent electrochemical energy storage devices are connected to each other in a gas-tight manner that is form-locking, bonded, or force-locking.

18. The battery case as recited in claim 15, wherein the lateral wall is connected to the cell frame in force-locking or form-locking manner, by clamping with a reinforcing frame.

19. The battery case as recited in claim 15, wherein the lateral wall is connected to the cell frame in bonded manner, the lateral wall being connected to the cell frame by adhesion or welding.

20. The battery case as recited in claim 15, wherein no significant pressure differences occur inside the battery case for extended periods, a common inner space of the battery case being created by the provision of pressure equalization recesses in these cell frames.

21. The battery case as recited in claim 15, further comprising an electronic battery controller for controlling at least one electrochemical energy storage device.

22. The battery case as recited in claim 15, wherein the lateral wall is made from a composite material.

23. The battery case as recited in claim 22, wherein the composite material is a fiber-reinforced plastic.

24. A battery comprising:
at least one electrochemical energy storage device; and
a battery case as recited in claim 15.

25. A method for operating a battery having a battery case as recited in claim 15, comprising:
recording selected, physically measurable parameters of the electrochemical energy storage devices via a battery controller;
comparing the measured parameters with definable target values; and
interrupting at least the electrical contact to the electrochemical energy storage device in response to a critical operating state, characterizable by the measured parameters, being reached.

26. The method for operating a battery as recited in claim 25, wherein
the temperature of at least one electrochemical energy storage device is recorded and compared with a target temperature, and
at least the electrical contact to this electrochemical energy storage device is disconnected when a predefinable shutoff temperature is reached.

27. The method for operating a battery as recited in claim 25, wherein
the actual pressure inside this battery case or inside an energy storage device is recorded and compared with a target pressure, and
at least the electrical contact to at least one electrochemical energy storage devices, is disconnected when a predefinable shutoff pressure is reached.

28. The method for operating a battery as recited in claim 27, wherein at least the electrical contact to all electrochemical energy storage devices is disconnected when the predefinable shutoff pressure is reached.

29. The method for operating a battery as recited in claims 25, wherein when at least one electrochemical energy storage device reaches a critical operating state characterized by a predefinable pressure and/or temperature, and a battery controller transmits a signal with which the operating state of the battery can be evaluated.
